(19) United States
(12) Patent Application Publication
(10) Pub. No.: US 2006/0262058 A1
(43) Pub. Date: Nov. 23, 2006

(54) Image display device with cholesteric liquid crystal display panel

(75) Inventors: Zenichiro Hara, Tokyo (JP); Noritaka Egami, Tokyo (JP); Masaaki Hiraki, Tokyo (JP); Yuusaku Saitou, Tokyo (JP)

Correspondence Address: BUCHANAN, INGERSOLL & ROONEY PC, POST OFFICE BOX 1404, ALEXANDRIA, VA, 22313-1404, US

(73) Assignee: MITSUBISHI DENKI KABUSHIKI KAISHA, Tokyo (JP)

(21) Appl. No.: 11/287,215

(22) Filed: Nov. 28, 2005

(30) Foreign Application Priority Data
May 23, 2005 (JP) 2005-149108

(51) Int. Cl. G09G 3/36

(52) U.S. Cl. 345/89

(57) ABSTRACT

A high-contrast halftone image is achieved by combining drives based on right- and left-hand characteristics of cholesteric liquid crystals. A first process displays a binary image of white and black based on the right-hand characteristics of voltage-reflectance characteristics. This achieves good black with a low reflectance. A subsequent second process displays an image based on driving voltages in the left-hand characteristics. The voltages in the left-hand characteristics produce good halftone displays. At this time, the liquid crystal state makes a transition in the direction of reducing the reflectance from planar to focal conic alignment. This allows high-contrast halftone displays while maintaining a good black level obtained in the first process.

### BACKGROUND OF THE INVENTION

1. Field of the Invention

The present invention relates to an image display device, and more specifically to a technique for driving cholesteric liquid crystal display panels.

2. Description of the Background Art

Recently, cholesteric liquid crystals with memory modes of operation have been focused on, and display devices with such cholesteric liquid crystals are being considered for practical applications (see for example Japanese Patent Application Laid-open No. 2002-14324).

Now, the operation of cholesteric liquid crystal display devices will be described. Cholesteric liquid crystals, when confined between a pair of parallel substrates in such a manner that their central axes of twist are, on average, perpendicular to the substrates, reflect circularly polarized light corresponding to the direction of their twist. This phenomenon is called “selective reflection,” and liquid crystalline order showing this selective reflection is called “planar alignment.” As another alignment than the planar alignment, cholesteric liquid crystals can also be in “focal conic alignment,” where the twist axes of a plurality of liquid crystal domains are oriented in random directions with respect to the substrates or in directions not perpendicular to the substrates. The focal conic alignment produces weak scattering of light and, unlike the selective reflection, does not reflect specific wavelengths of light (visible light). Thus, by application of pulsed voltage to cholesteric liquid crystals, we can change the liquid crystalline order from the planar to the focal conic alignment, or vice versa, depending on the amplitude of the voltage. The focal conic to planar transition occurs via a liquid crystal orientation (called “homeotropic”) where liquid crystal molecules are almost parallel to the direction of electric field application, so that application of the highest write voltage is required for causing that transition (see for example Japanese Patent Application Laid-open No. 2002-202495).

In display devices using cholesteric liquid crystals, image display is provided by changing the amplitude of applied voltage to change the orientation of liquid crystal molecules, as above described, and thereby to control reflection of external light. For effective representation of displayed images on panel screens, it is important to improve the ratio of reflectance between white (planar alignment) and black (focal conic alignment), i.e., the contrast, of displayed images.

In conventional cholesteric liquid crystal displays, since the left-hand characteristics of voltage-reflectance characteristics for cholesteric liquid crystals in FIG. 3 show gentle changes in reflectance with respect to applied voltages (VA to VB); a driving method based on the left-hand characteristics is solely employed for halftone display, which is the requirement for full-color image display.

However, when focusing on a black display, a black level in the case based on the left-hand characteristics (black display L in FIG. 3) shows higher scattering of light in the focal conic alignment and thereby increases the brightness of black, as compared to a black level in the case based on the right-hand characteristics (black display R in FIG. 3). Thus, using the left-hand characteristics has a problem of lower contrast. To improve the contrast, a reduction of the black level is important.

On the other hand, although certainly a better black level (with a lower reflectance and lower brightness of black) is achieved by the use of the right-hand characteristics of FIG. 3, the right-hand characteristics show abrupt changes in reflectance with respect to applied voltages (VC to VD) and thus are not suitable for halftone representation. Saturated color reproduction is possible, but there are limitations in color image representation.

### SUMMARY OF THE INVENTION

The present invention is intended to solve the aforementioned problems, and its object is to allow high-contrast halftone image displays with cholesteric liquid crystal display devices.

The image display device according to the principles of the present invention includes a liquid crystal display panel using cholesteric liquid crystals, and a drive system configured to drive the liquid crystal display panel.

The drive system, when an original image to be displayed on the liquid crystal display panel includes halftone components, displays a first image by a first drive and displays a second image by a second drive while maintaining a display of the first image on the liquid crystal display panel, thereby to display the original image on the liquid crystal display panel. The first drive is such that a first drive signal, which is determined by using right-hand characteristics of voltage-reflectance characteristics for the cholesteric liquid crystals based on the original image, is applied to the liquid crystal display panel. The second drive is such that, following the first drive, a second drive signal, which is determined by using left-hand characteristics of the voltage-reflectance characteristics based on the original image, is applied to the liquid crystal display panel.

In cholesteric liquid crystal displays, by controlling a to-be-displayed image based firstly on the right-hand characteristics, a first image with a high reflectance in white display and a sufficiently low and good black level is achieved. With the display of the first image maintained, a halftone image is further superimposed and displayed on the first image, based on the left-hand characteristics. This allows halftone displays while maintaining a good black level, thereby allowing a display of a high-contrast second image.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a conceptual diagram showing an example of the structure of an image display device according to the present invention;

FIG. 2 is a block diagram showing an example of the structure of an image display device according to a first preferred embodiment of the present invention;

FIG. 3 is a diagram showing voltage-reflectance characteristics for cholesteric liquid crystals;

FIGS. 4 and 5 are flow charts showing the operation of the image display device according to the first preferred embodiment of the present invention;

FIGS. 6A and 6B illustrate a right-hand drive for images without halftone components in the image display device according to the first preferred embodiment of the present invention;

FIGS. 7A to 7C illustrate right- and left-hand drives for images with halftone components in the image display device according to the first preferred embodiment of the present invention;

FIG. 8 is a block diagram showing an example of the structure of an image display device according to a second preferred embodiment of the present invention;

FIG. 9 is a flow chart showing, in the case of images with halftone components, the operation of the image display device according to the second preferred embodiment of the present invention;

FIGS. 10A to 10C illustrate right- and left-hand drives for images with halftone components in the image display device according to the second preferred embodiment of the present invention;

FIG. 11 is a block diagram showing an example of the structure of an image display device according to a third preferred embodiment of the present invention;

FIG. 12 is a flowchart showing, in the case of images with halftone components, the operation of the image display device according to the third preferred embodiment of the present invention;

FIGS. 13A to 13C are diagrams showing the principle of binary image production according to a fourth preferred embodiment of the present invention;

FIG. 14 is a block diagram showing an example of the structure of an image display device according to the fourth preferred embodiment of the present invention;

FIG. 15 is a flowchart showing, in the case of images with halftone components, the operation of the image display device according to the fourth preferred embodiment of the present invention;

FIG. 16 is a flowchart showing, in the case of images with halftone components, the operation of an image display device according to a fifth preferred embodiment of the present invention; and

FIG. 17 is a block diagram showing an example of the structure of a large image display apparatus according to a sixth preferred embodiment of the present invention.

### DESCRIPTION OF THE PREFERRED EMBODIMENTS

(Features of Image Display Devices of the Invention and Principles in Display)

Image display devices according to the present invention are characterized in that, in cholesteric liquid crystal displays, a display by a first drive based on the right-hand characteristics (abrupt changes) of the voltage-reflectance characteristics for cholesteric liquid crystals is followed by a display by a second drive based on the left-hand characteristics (gentle changes) of the above voltage-reflectance characteristics, which display is superimposed on a first screen obtained by the first drive, whereby a to-be-displayed image is displayed on a cholesteric liquid crystal display panel. Such combination of the first drive based on the above right-hand characteristics, which achieve a black level required for high contrast representation, and the second drive based on the above left-hand characteristics, which is required for halftone representation, achieves high contrast image displays on cholesteric liquid crystal display panels.

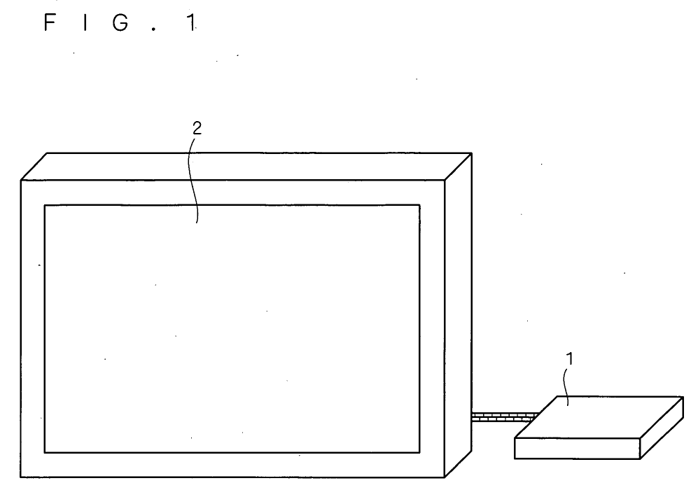

The image display devices according to the present invention, as illustrated in FIG. 1, mainly comprise a display unit 2 using cholesteric liquid crystals and a control unit 1 for storing image data to be displayed and controlling cholesteric liquid crystal displays. Especially in the present invention, a circuit system consisting of the control unit 1 and a circuit system in the display unit 2 excepting a cholesteric liquid crystal display panel is referred to as a “drive system” for driving a liquid crystal display panel.

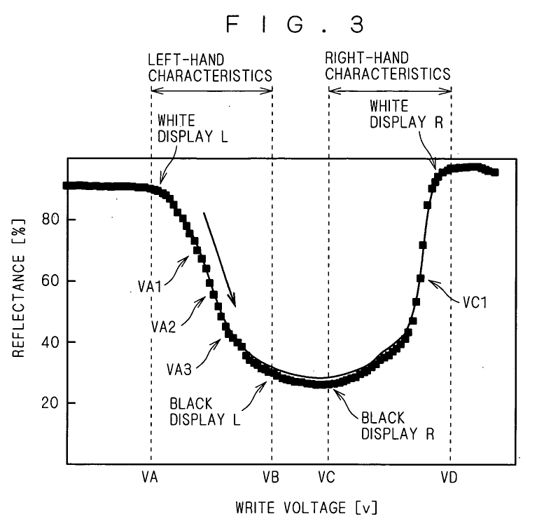

The drive system forming the heart of the control unit 1 combines display controls based respectively on the right- and left-hand characteristics of the voltage-reflectance characteristics for cholesteric liquid crystals in FIG. 3, thereby to display, at a time, a single frame of original image stored in the control unit 1. For example, for display of full color images such as photographs on the display unit 2, halftone representation is necessary. Thus, for the display of full color images, firstly, a first image with a sufficiently bright saturated color and a sufficiently low black level is obtained by the display control based on the right-hand characteristics of FIG. 3. Since cholesteric liquid crystals have a memory characteristic as previously described, this first image will be retained until next image refresh (i.e., until the next frame of original image is displayed). At the time of image refresh, a transition from the focal conic alignment corresponding to a black state to the planar alignment corresponding to a white state (switching from black to white display) requires application of a high voltage for transition via a homeotropic state (see the right-hand characteristics of FIG. 3). On the other hand, at the drive based on the left-hand characteristics of the voltage-reflectance characteristics (hereinafter referred to as a “left-hand drive”), application of the driving voltages VA to VB for image display to the liquid crystal display panel causes the characteristics to transition in the direction of the arrow in FIG. 3, i.e., in the direction of reducing the reflectance from the planar to the focal conic alignment, in which case the black level with the minimum reflectance is maintained. That is, in the presence of a first image which is displayed by the drive based on the right-hand characteristics of the voltage-reflectance characteristics (hereinafter referred to as a “right-hand drive”), original image data with halftones is superposed and displayed on the first image, based on the driving voltages VA to VB in the left-hand characteristics. This allows, while maintaining a good black level in the first image, the generation of a second image including halftone display, in which brightness changes to the reflectance corresponding to the driving voltage.

Now, with reference to the drawings, the image display devices according to the respective preferred embodiments will be described in detail.

### First Preferred Embodiment

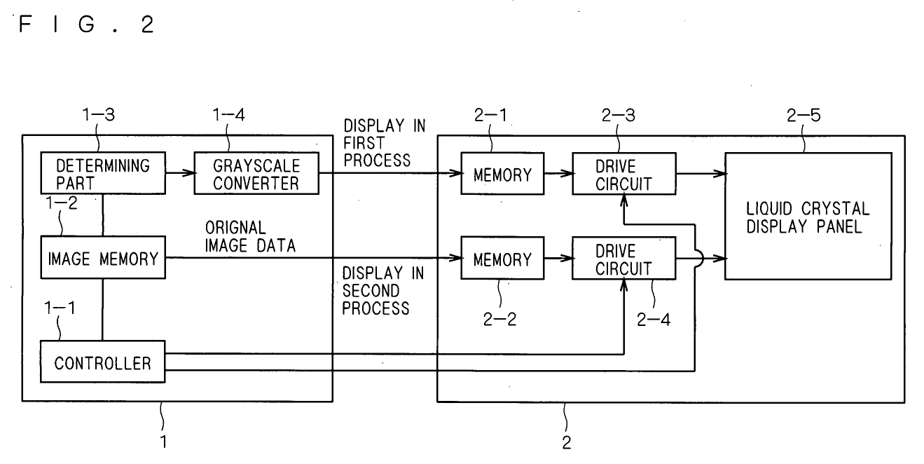

FIG. 2 is a block diagram schematically showing an example of the structure of an image display device according to this preferred embodiment. As shown in FIG. 2, the image display device comprises the control unit 1 for image control and the display unit 2. While, in FIG. 2, the display unit 2 and the control unit 1 are shown separately as in FIG. 1, the control unit 1 may be incorporated in the display unit 2. The same can be said of the other preferred embodiments to be described later.

Referring to FIG. 2, the display unit 2 comprises a liquid crystal display panel 2-5 using cholesteric liquid crystals as display devices, a first drive circuit 2-3 displaying one frame of first image by the right-hand drive on the liquid crystal display panel 2-5, a first memory 2-1 storing relatively rough halftone data as will be described later, a second drive circuit 2-4 displaying one frame of second image by the left-hand drive on the liquid crystal display panel 2-5 in such a manner that a halftone image is superimposed on the first image, and a second memory 2-2 storing one frame of original image data.

The control unit 1 comprises a controller 1-1 forming the heart of control, an image memory 1-2 storing all frames of original image data to be displayed on the liquid crystal display panel 2-5, a determining part 1-3 determining whether an image to be displayed contains halftone components, and a grayscale converter 1-4 converting the gray scale of original image data when the image to be displayed contains halftone components.

Addressing for data writing and reading to and from the first and second memories 2-1 and 2-2 is controlled by the controller 1-1. The drive timing of the respective first and second drive circuits 2-3 and 2-4 is controlled by timing signals from the controller 1-1. Reading of original image data from the image memory 1-2 is also controlled by the controller 1-1.

When transmitting an image to the display unit 2, the control unit 1 determines the presence or absence of halftone components in the image, and according to the presence or absence of halftone components, selects an optimum driving method which is the combination of the right- and left-hand characteristics of FIG. 3. By so doing, the control unit 1 gets the best out of display device performance, thereby achieving high contrast display.

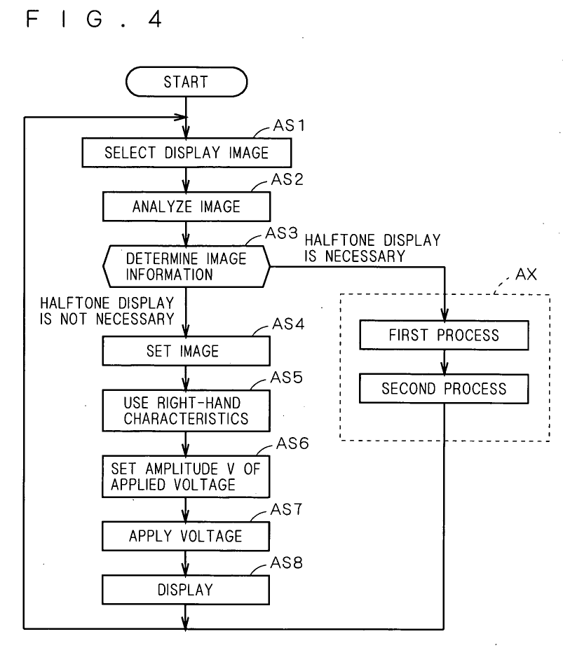

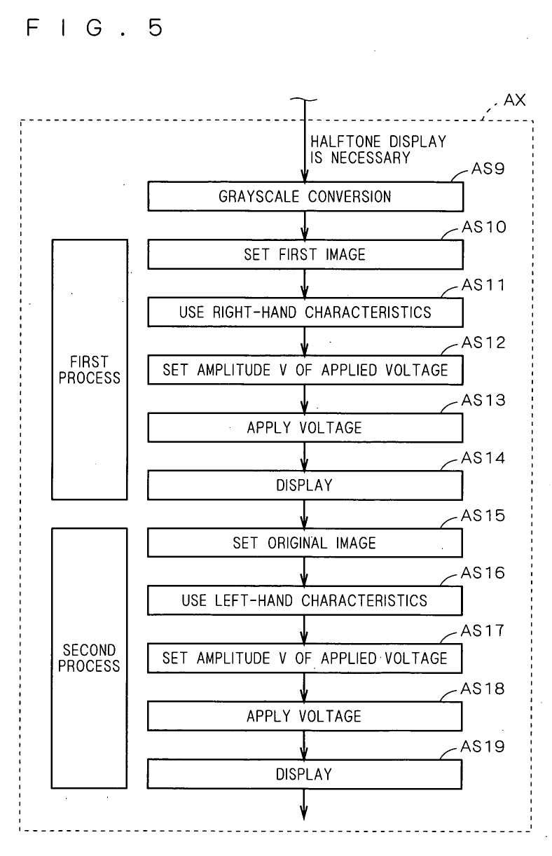

Next, the operation will be described. FIGS. 4 and 5 are flowcharts showing the operation of the image display device (in FIG. 2) according to this preferred embodiment. Especially, FIG. 5 is a flowchart showing the details of a step AX in FIG. 4 which corresponds to the case where the representation of halftone components is required. The step AX mainly consists of a first process (a display by the first drive) and a second process (a display by the second drive) following the first process. Now, each of the steps in FIGS. 4 and 5 will be described with reference to FIG. 2.

Firstly, for image display on the image display device, the controller 1-1 selects one frame of original image data to be displayed on the display unit 2, from images stored in the image memory 1-2 in the control unit 1 (AS1). Then, the determining part 1-3 analyzes color information used in the selected image (AS2) and determines whether the image contains halftone components (AS3). As one example of the analysis methods, the determining part 1-3 checks each bit of image data. If the values of the respective bits are all 0 or all 1, the determining part 1-3 determines that this is the case of displaying a saturated color image (binary image) without halftones. According to this method, if image data includes both 0 and 1, the determining part 1-3 determines that the selected image is an image with halftones.

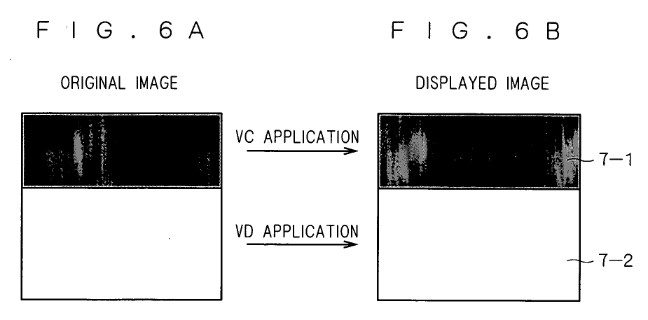

When determined as a saturated color image without halftone components, the image is set in the first memory 2-1 in FIG. 2 without grayscale conversion (AS4), and the first drive circuit 2-3 performs display control based on the above right-hand characteristics (AS5). More specifically, the first drive circuit 2-3 selects white and black of each pixel, i.e., voltages VD and VC corresponding respectively to reflection and transmission modes of cholesteric liquid crystals (AS6), and applies those voltages VD and VC to the liquid crystal display panel 2-5 (AS7). As a result of this, the liquid crystal display panel 2-5 displays the selected image (AS8). FIGS. 6A and 6B show an example of displaying an image without halftones. For example, the voltages VC and VD are applied respectively to a black portion 7-1 and a white portion 72 of the original image in FIG. 6A to display an image as shown in FIG. 6B.

For images with halftone components, as shown in FIG. 4, the same frame of original image is firstly subjected to the first process and then to the second process after completion of the first process. Now, the details of the first and second processes will be described with reference to the step AX of FIG. 5.

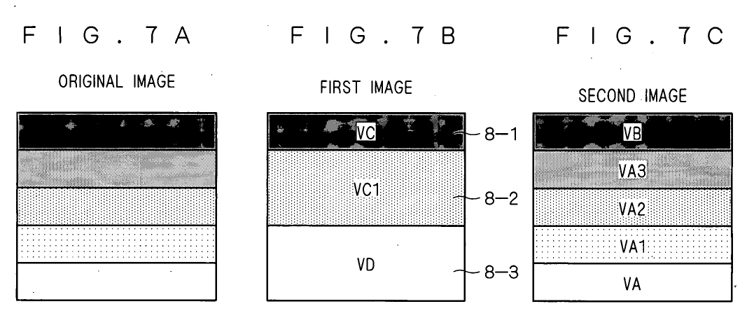

In the first process, the grayscale converter 1-4 in the control unit 1 converts a selected one frame of original image data into an image with rougher halftone components than the original image, and sets this converted image data including halftone components with less shades of gray, in the first memory 2-1 in the display unit 2. The first drive circuit 2-3, in response to an instruction to start the first drive from the controller 1-1, displays the selected image data as a first image on the liquid crystal display panel 2-5 by the first drive based on the right-hand characteristics. The right-hand characteristics showing abrupt changes are generally not suitable for halftone display but can be used for rough halftone display. A rough halftone image defined here is an image with less shades of gray than the original image. Referring to FIG. 5, firstly, the gray scale of the original image is converted into a reduced gray scale (AS9); a first image obtained by the grayscale conversion is set in the first memory 2-1 (AS10); and according to data on the first image, predetermined voltages in the right-hand characteristics are applied to the liquid crystal display panel 2-5 (AS11, AS12, AS13), whereby a rough first image is displayed (AS14). One example of the grayscale conversion methods is a method of setting low-order bits of data forcefully to 0 or 1. For example, in the case of a 6-bit image with 64 shades of gray, setting the least significant bit to 0 or 1 will reduce the number of shades of gray to 32, and setting the two least significant bits both to 0 or 1 will reduce the number of shades of gray to 16. In the examples shown in FIGS. 7A to 7C, for the sake of simplifying the explanation, FIG. 7A shows the original image with 5 shades of gray, and FIG. 7B shows the first image with 3 shades of gray. In the display of FIG. 7B, the voltages VC, VC1 and VD in the right-hand characteristics of FIG. 3 are applied respectively to a black portion 8-1, a gray portion 8-2, and a white portion 8-3, thereby to display a first image with less shades of gray. The first image in FIG. 7B will be retained until next image refresh, due to the memory characteristic of cholesteric liquid crystals. Accordingly, the display of the first image in FIG. 7B is maintained in the subsequent second process, and as will be described later, a display by the second drive in the second process is superimposed on the first image.

In the subsequent second process, the controller 1-1 in the control unit 1 reads the original image data in FIG. 7A from the image memory 1-2 and sets it again in the second memory 2-2 in the display unit 2 (AS15). Under control of the controller 1-1, the second drive circuit 2-4 determines and sets voltages to be applied, based on the original image data and the left-hand characteristics (AS16, AS17), thereby to display a halftone image of the original image (AS18, AS19). At this drive, driving voltages VA, VA1, VA2, VA3, and VB are set within the range of the voltage VA for white display to the voltage VB for black display to meet the gray scale of the original image data in FIG. 7A in accordance with the left-hand characteristics of FIG. 3, and those voltages VA, VA1, VA2, VA3, and VB are applied to the cholesteric liquid crystals (AS17, AS18), whereby the second image of FIG. 7C is displayed on the liquid crystal display panel 2-5 (AS19). At the left-hand drive, application of driving voltages for image display causes the characteristics to transition in the direction of the arrow in FIG. 3, i.e., in the direction of reducing the reflectance from the planar to the focal conic alignment. Accordingly, the first process achieves a good black level, and the subsequent second process, i.e., the left-hand drive by application of the voltages between VA and VB rewrites a rough halftone image with an image with more shades of gray. At this time, a good black level that has been produced by the application of the driving voltage VC at the right-hand drive in the first process is maintained in the second process, thereby achieving high contrast display.

### Second Preferred Embodiment

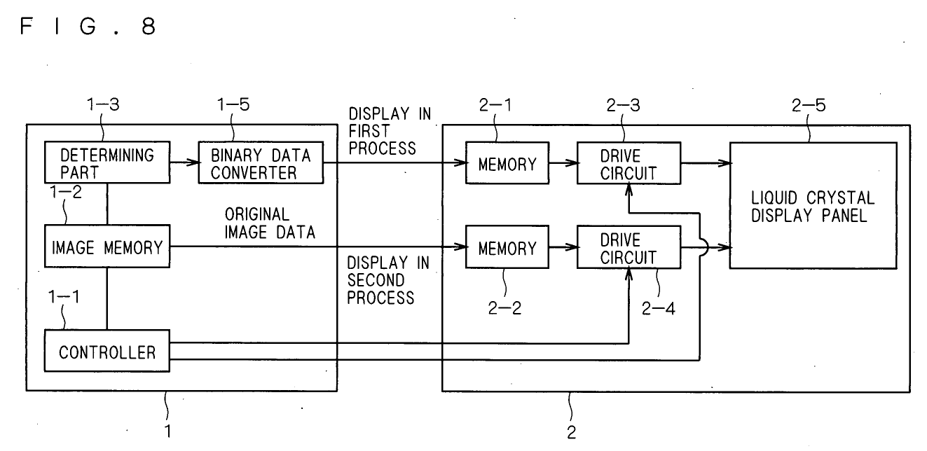

In the first preferred embodiment, a rough halftone first image is obtained by reducing the number of shades of gray in the original image with the grayscale converter 1-4 in FIG. 2. In the display in the second process based on the left-hand characteristics of FIG. 3, brightness changes in the direction of the arrow, i.e., in the direction of darkness. Thus, the display of the first image in FIG. 7B obtained by the application of the voltage VC1 needs to be brighter than or at least at the same level of brightness as the display of the second image in FIG. 7C obtained by the application of the voltage VA2. However, in actual display with the voltage VC1, since the right-hand characteristics show a sharp curve, brightness varies with temperature changes and the like. From this, if the display with the voltage VC1 is darker than the display of the second image obtained by the application of the voltage VA2, there is a possibility that a proper second image cannot be displayed. Considering this fact, in the first process according to this preferred embodiment, an original image is converted into a binary image of white and black, which then is displayed as a first image. In the subsequent second process, the original image is displayed based on the left-hand characteristics. Now, the circuit configuration and operation according to this preferred embodiment will be described with reference to FIGS. 8 to 10.

FIG. 8 is a block diagram schematically showing an example of the circuit configuration of an image display device according to this preferred embodiment, which diagram is a circuit diagram corresponding to the one described in FIG. 2. The circuit configuration of FIG. 8 differs from that of FIG. 2, in that the grayscale converter 1-4 for generating a rough halftone image from an original image is replaced by a binary data converter 1-5 for identifying a black portion and portions other than black, of an original image with halftones to convert the original image into binary data. The other components are identical to those in FIG. 2.

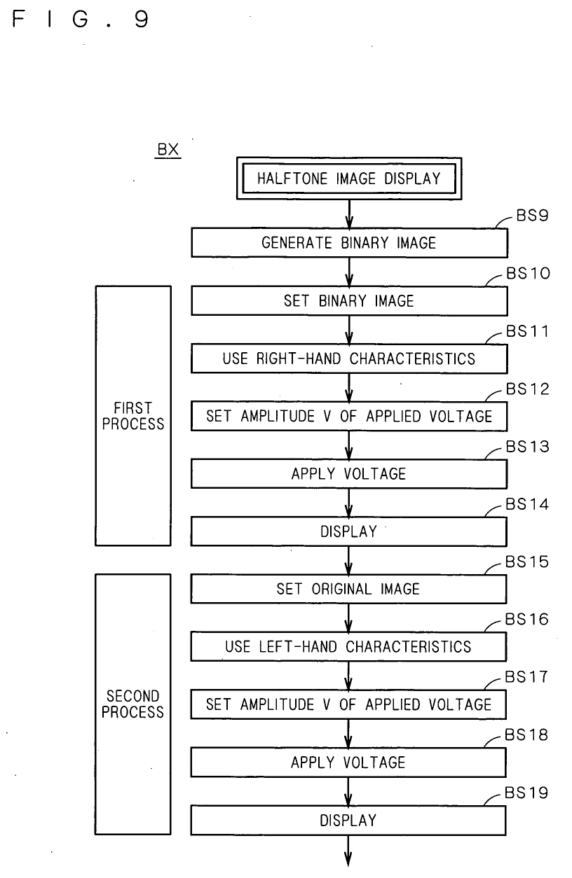

FIG. 9 is a flowchart showing the step AX (encircled part by the broken line) in FIG. 4 for processing on images with halftones, i.e., a flowchart corresponding to FIG. 5.

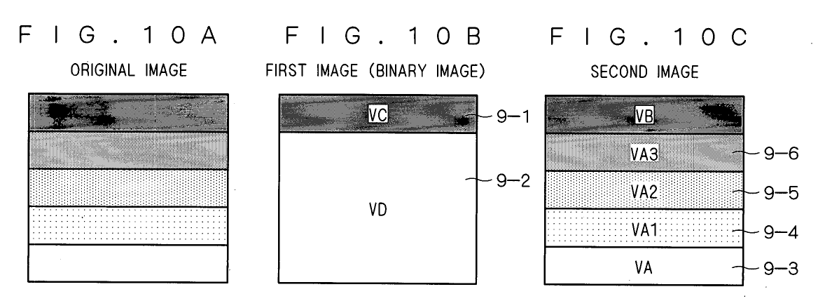

In the first process, the binary data converter 1-5 in the control unit 1 converts one frame of original image data, which has been read from the image memory 1-2 by the controller 1-1, into a binary image (BS9) and sets first image data describing the binary image in the first memory 2-1 in the display unit 2 (BS10). Under control of drive start timing given by the controller 1-1, the first drive circuit 2-3 in the display unit 2 displays the binary image based on the right-hand characteristics (BS11 to BS14). For example, conversion into the binary image as shown in FIGS. 10A and 10B is accomplished in such a manner that a portion represented by image data whose bits are all 0 is set to black, while data greater than 0 is all converted into 1 for correspondence with a white display. In such a conversion technique, an original image of FIG. 10A is converted into a first image of FIG. 10B which is a binary image. Then, based on the right-hand characteristics of FIG. 3, the voltages VC and VD are applied respectively to a black portion 9-1 and the other white portion 9-2 (BS12, BS13), whereby the image of FIG. 10B is displayed (BS14). The image of FIG. 10B will be retained until next image refresh, due to the memory characteristic of cholesteric liquid crystals. The black level obtained with the driving voltage VC at this time is good black with a low reflectance, thus contributing to contrast improvement.

In the second process following the first process, the controller 1-1 in the control unit 1 sets the original image of FIG. 10A again in the second memory 2-2 in the display unit (BS15). Then, according to clock timing transmitted from the controller 1-1 to indicate the start of the second drive, the second drive circuit 2-4 displays a halftone image of the original image based on the left-hand characteristics of FIG. 3 (BS16 to BS19). At this drive, the driving voltages VA, VA1, VA2, VA3, and VB are set within the range of the voltage VA for white display to the voltage VB for black display to meet the gray scale of the original image of FIG. 10A, thereby producing a white portion 9-3 and fine halftone portions 9-4, 9-5, and 9-6 as shown in FIG. 10C. Then, by application of the above voltages to the cholesteric liquid crystals, a second image is displayed on the liquid crystal display panel 2-5. At the left-hand drive, application of driving voltages for image display causes the characteristics to transition in the direction of the arrow in FIG. 3, i.e., in the direction of reducing the reflectance from the planar to the focal conic alignment.

Accordingly, the first process provides a display of the binary image of good white and black, and the left-hand drive in the subsequent second process converts the white portion 9-2 of the binary image (first image) into predetermined levels of brightness (i.e., portions 9-3 to 9-6) according to driving voltages while maintaining a good black level, thereby achieving accurate and high contrast display without being influenced by temperature changes and the like.

### Third Preferred Embodiment

For display control in the image display device of FIG. 1, the driving methods according to the first and second preferred embodiments first require transmission of data which has been converted into either a rough halftone or binary image, to the display unit 2 for display of the first image by the right-hand drive, and then require another transmission of original image data from the control unit 1 to the display unit 2 for display control by the left-hand drive. This results in an increase in the amount of information to be transmitted to the display unit 2, thereby slowing down the speed of updating displays in correspondence with the time required for another transmission of original image data, and also requiring an additional memory for previous setting of original images in the display unit 2. In both the cases of FIGS. 2 and 8, the display unit 2 includes two memories (while conventional display units include only a single memory). This preferred embodiment is intended to solve such a problem.

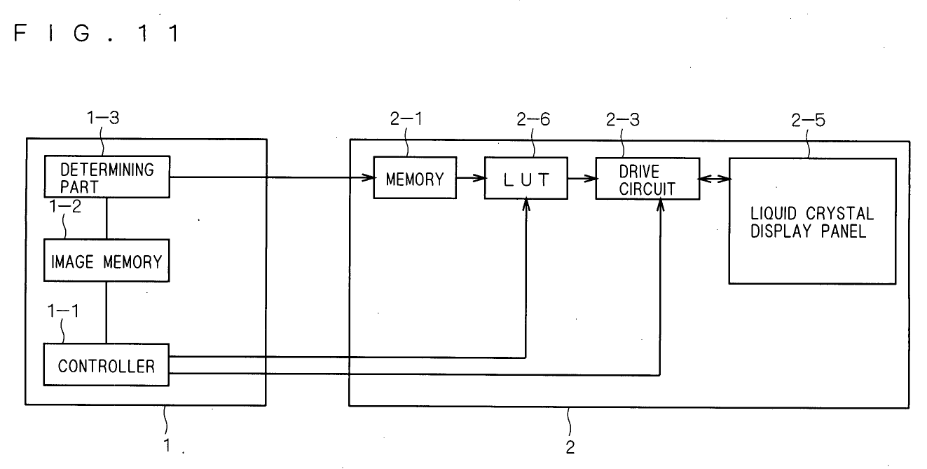

FIG. 11 is a block diagram schematically showing an example of the structure of an image display device according to this preferred embodiment. As shown in FIG. 11, the control unit 1 comprises the controller 1-1, the image memory 1-2, and the determining part 1-3; and the display unit 2 comprises the memory 2-1, a look-up table (hereinafter simply referred to as a “LUT”; the LUT is a storage for storing data in a look-up table) 2-6, the drive circuit 2-3, and the liquid crystal display panel 2-5 using cholesteric liquid crystals. In this preferred embodiment, the controller 1-1 has the functions of controlling writing and reading to and from the image memory 1-2 and the memory 2-1; giving first and second drive start timing to the drive circuit 2-3 for control of the drive circuit 2-3; and setting first conversion table data for the first drive and second conversion table data for the second drive in the LUT 2-6.

Here, common original image data is used as image data for both the right- and left-hand drives in the first and second processes, and the LUT 2-6 performs each data conversion necessary for the right- and left-hand drives. Thus, in this preferred embodiment, data destined for another transmission from the control unit 1 to the display unit 2 is only conversion information to be set in the LUT 2-6 for the left-hand drive, which considerably shortens the transmission time as compared to the case where another transmission of image data is necessary. Besides, a common memory (the memory 2-1) can be used for setting each image data necessary for the first and second processes. This inhibits a reduction in the speed of updating displays, which reduction is associated with the assurance of transmission time necessary for another transmission of original image data as required in the first preferred embodiment, and also eliminates the necessity of providing an additional memory for previously storage of original image data, thereby simplifying the hardware (H/W) structure.

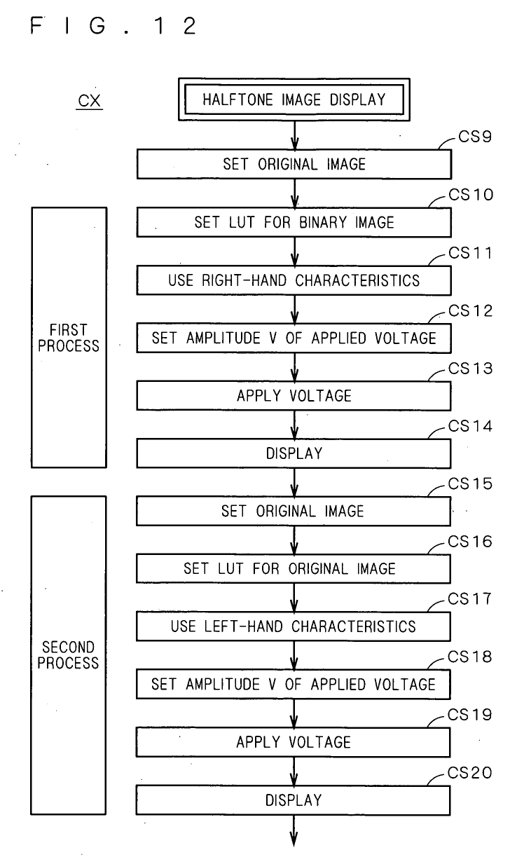

Next, the operation according to this preferred embodiment will be described with reference to the flowchart of FIG. 12. Like FIG. 9, FIG. 12 shows a step CX corresponding to the step AX (encircled part by the broken line) in FIG. 4 for processing on images with halftones. Firstly in the first process, the controller 1-1 reads one frame of original image data from the image memory 1-2 and sets the original image data in the memory 2-1 (CS9). Further, the controller 1-1 sets in the LUT 2-6, the first conversion table data corresponding to the right-hand drive (conversion table data for binary images), which table data has been produced based on the right-hand characteristics of FIG. 3 (CS10). The LUT 2-6, based on the first conversion table data, converts the original image data read from the memory 2-1 into voltage data corresponding to the voltage VC for a black display and the voltage VD for a white display at the right-hand drive (CS11, CS12). The drive circuit 2-3, in response to first drive start timing given by the controller 1-1, applies the voltages VC and VD to the liquid crystal display panel 2-5 (CS13), thereby to display a first image which is a binary image (CS14). At this time, a good black level is obtained, which is a requisition for high contrast display. In the subsequent second process, the controller 1-1 sets in the LUT 2-6, the second conversion table data corresponding to the left-hand drive (conversion table data for original image data), which table data has been produced based on the left-hand characteristics of FIG. 3 (CS16). The LUT 2-6, based on the second conversion table data, outputs voltage data corresponding to the voltages VA to VB according to the gray scale of the original image data, and the drive circuit 2-3 displays a second image by the second drive on the liquid crystal display panel 2-5 (CS17 to CS20). This second process provides a high-contrast halftone image while maintaining a good black level in the first image.

While, in the above description, the first process of this preferred embodiment adopts the case of displaying a binary image by the first drive as described in the second preferred embodiment, this preferred embodiment may adopt the first process described in the first preferred embodiment. In the first process in this case, for example, first conversion table data which converts original image data into the voltages VC, VC1, and VD in FIG. 3 (see FIG. 7) is set in the LUT 2-6 by the controller 1-1. The drive circuit 2-3 in this case, in response to the first drive start timing given by the controller 1-1, applies the voltages VC, VC1, and VD to the liquid crystal display panels 2-5 (CS13), thereby to display the first image which is a rough halftone image (CS14). The processing in the second process in this case is identical to that in the case of displaying a binary image by the first drive.

### Fourth Preferred Embodiment

In the second and third preferred embodiments, as in the example where the color of image given by data whose bits are all 0 is determined as black, the determination in the conversion of image data into a binary image is based on a comparison of each image data and a certain value such as 0. However, the actual black level varies slightly due to the influence of noise and the like during the process of producing original image data (such as reading with a scanner).

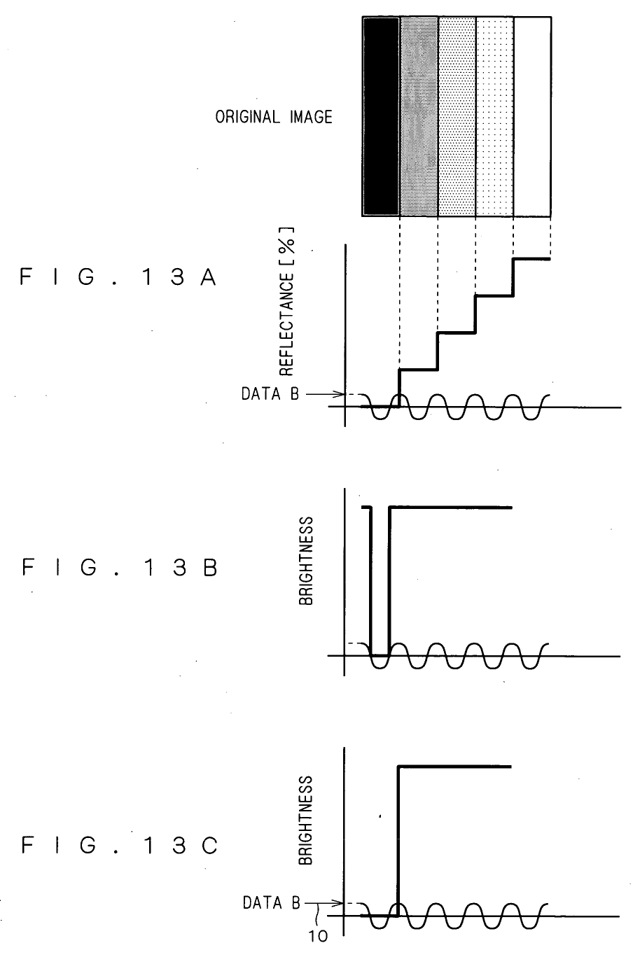

FIG. 13A shows variations in the black level in addition to the relationship between the original image and the reflectance. If black is determined by reference to whether the value of image data is 0, variations in the black level of the original image as shown in FIG. 13A may hinder accurate determination as shown in FIG. 13B.

Thus, data to be a criterion for determining the black level, namely data B shown in FIG. 13C, is defined as a criterion value (threshold value) 10 for determining the black level, and this data B (threshold value) is set to be variable. For example, the following determination is made:

If image data>data B, the result is white; and

If image data≦data B, the result is black.

FIG. 13C is a graph of brightness showing the discrimination between white and black made by this criterion. According to this definition, the second and third preferred embodiments describe the case where data B=0.

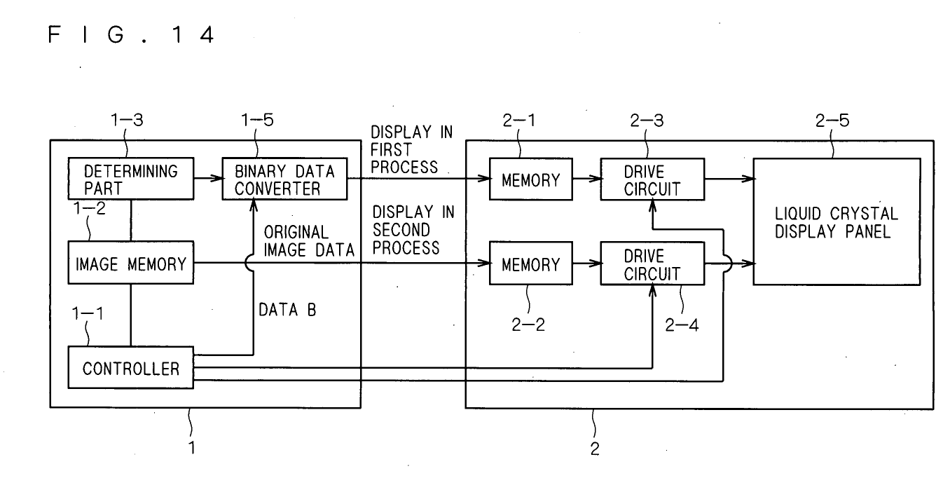

FIG. 14 is a block diagram showing an example of the structure of an image display device according to this preferred embodiment in the case where the device of FIG. 8 in the second preferred embodiment employs the above technique using the criterion value 10 for discrimination between white and black. The feature is that the controller 1-1 instructs the binary data converter 1-5 to set variable the data B which is the criterion value 10. That is, the criterion value 10 (data B) in the binary data converter 1-5 is set at any arbitrary value by the controller 1-1.

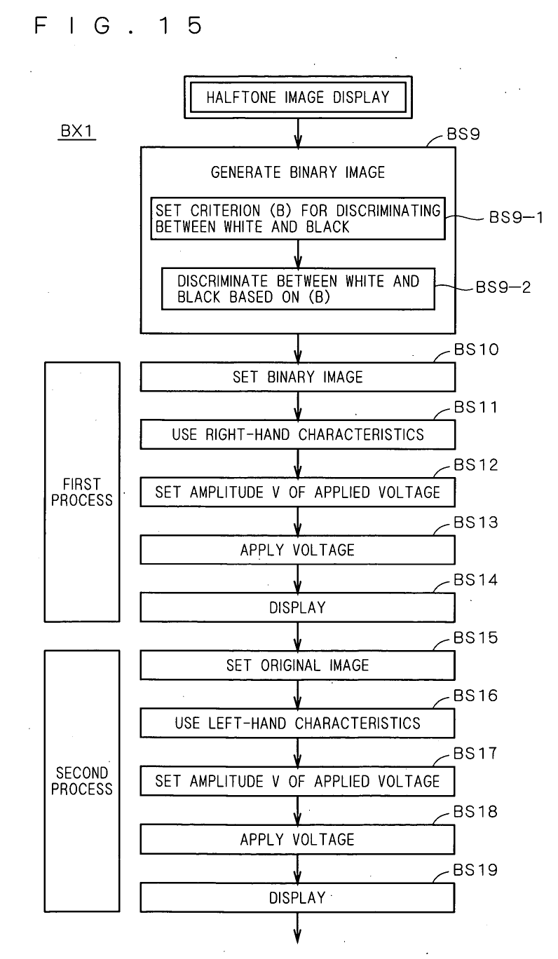

FIG. 15 is a flowchart according to this preferred embodiment, corresponding to FIG. 9 of the second preferred embodiment. Those steps in FIG. 15 which are denoted by the same reference characters as in FIG. 9 have common functions as their corresponding steps in FIG. 9, and thus will not be described here. In FIG. 15, the controller 1-1 sets the data B in the binary data converter 1-5 in step BS9-1, and based on the data B, the binary data converter 1-5 discriminates between white and black levels in the original image to produce a binary image (first image) in step BS9-2.

In this way, by setting variable the value of data B which is a criterion value for generating a binary image, appropriate black-level setting as shown in FIG. 13C is possible even with variations in the black level of the original image due to the influence of noise.

The aforementioned feature of this preferred embodiment (i.e., setting the data B variable) is also applicable to the device of FIG. 11 in the third preferred embodiment. In this case, the circuit configuration of the image display device remains unchanged. For example, based on the example shown in FIG. 10B, the controller 1-1 in the first process sets the first conversion table data in the LUT 2-6, in which table data, if image data≦data B, applied voltage corresponding to the image data is converted into the voltage VC for the black level, and if image data>data B, applied voltage corresponding to the image data is converted into the voltage VD for the white level. Thereby, in the first process, the LUT 2-6 and the drive circuit 2-3 displays a binary image (first image) obtained using the data B of any arbitrary value as a criterion, on the liquid crystal display panel 2-5.

### Fifth Preferred Embodiment

In the fourth preferred embodiment, the data B as a criterion for discriminating between white and black is set variable. However, in order to simplify image display, it is effective to optimize the data B used for discrimination between white and black, in the previous process of producing image data. More specifically, the data B as a criterion for discriminating between white and black is optimized for each image (each frame of image data) and added to the image as attribute information. As a result, at the time of displaying each image (one frame of image data), the sizes of image data and the data B can be checked (image data is determined as white when image data>data B and determined as black when image data≦data B). This allows appropriate black-level setting.

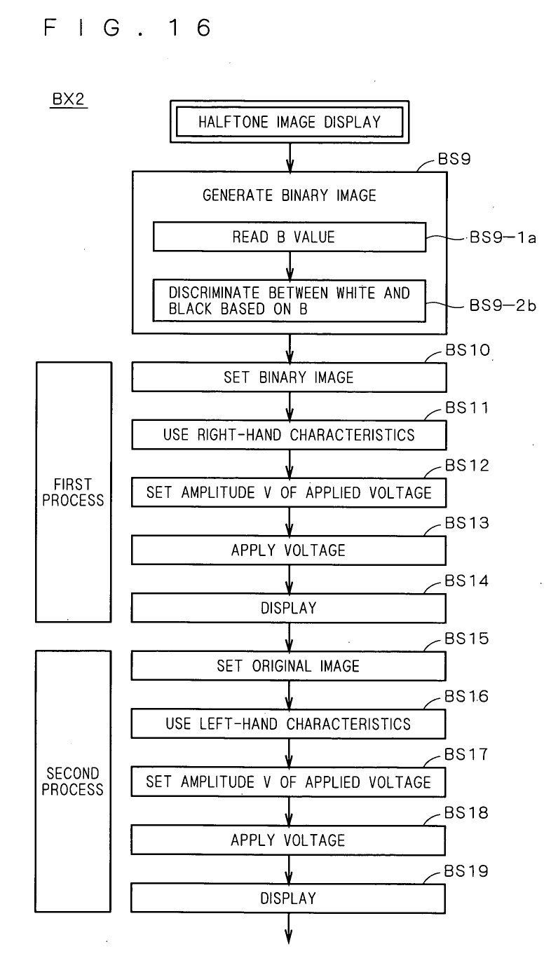

FIG. 16 is a flowchart according to this preferred embodiment, corresponding to FIG. 9 of the second preferred embodiment. In FIG. 16, the same reference characters as in FIG. 9 indicate the same functions and thus will be not be described here.

In FIG. 16, in step BS9-1a, the controller 1-1 reads the value of data B which has previously been added to image data as attribute information. Then, in step BS9-2b, a binary image is produced by discrimination between white and black based on the data B. For example, in the case of applying the second preferred embodiment to this preferred embodiment, the controller 1-1 sets the data B read for each image in the binary data converter 1-5, and based on the data B, the binary data converter 1-5 produces a binary image for each image to be displayed. On the other hand, in the case of applying the third preferred embodiment to this preferred embodiment, the controller 1-1, using the data B read for each image as a criterion value for discriminating between white and black, produces the first conversion table data based on the right-hand characteristics for each image to be displayed and sets the first conversion table data in the LUT 2-6.

As so far described, in this preferred embodiment, the value of data B is previously optimized for each image to be displayed, so that appropriate black-level setting as shown in FIG. 13C is possible for each image to be displayed.

### Sixth Preferred Embodiment

This preferred embodiment provides an example of applying the image display device of the third preferred embodiment (cf. FIG. 11) to a large image display apparatus.

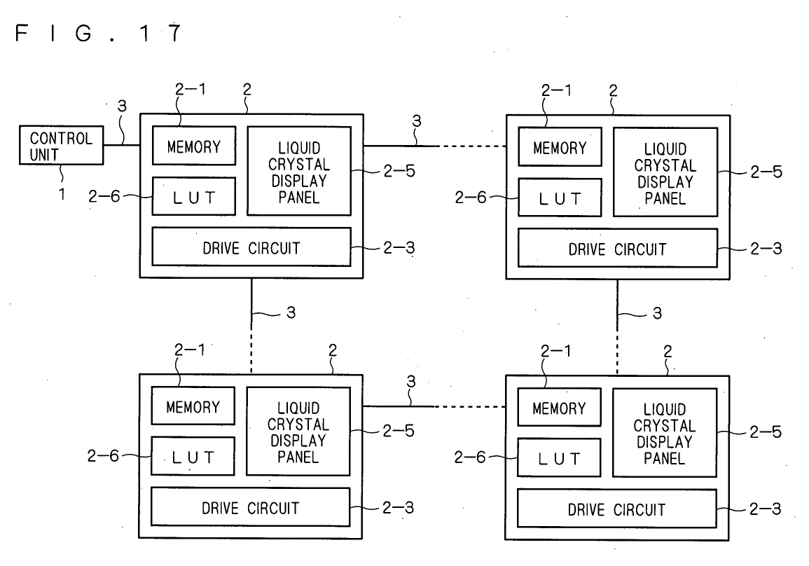

FIG. 17 is a block diagram schematically showing an example of the structure of a large image display apparatus according to this preferred embodiment. As shown in FIG. 17, a large display consisting of an array of a number of cholesteric liquid crystal display panels is configured such that a number of display units 2 each comprising the memory 2-1, the LUT 2-6, the drive circuit 2-3, and the liquid crystal display panel 2-5 are connected through a transmission line 3 to the control unit 1. The control unit 1 here corresponds to the one illustrated in FIG. 11 and comprises the controller 1-1, the image memory 1-2, and the determining part 1-3. Especially, the image memory 1-2 here retains original image data to be displayed on each display unit 2. The controller 1-1 reads corresponding original image data to be displayed on each display unit 2 from the image memory 1-2 and transmits the read original image data to a corresponding one of the display units 2 through the transmission line 3. Each of the display units 2 has a look-up table for displaying an image by combining the driving methods based on the right- and left-hand characteristics of the driving voltage vs. reflectance characteristics. When updating displays, the control unit 1 transmits a corresponding image to each display unit 2 through the transmission line 3.

Next, the operation of this apparatus in the case where images contain halftone components will be described. Firstly, the control unit 1 (controller 1-1) transmits corresponding original image data to each display unit 2. The memory 2-1 in each display unit 2 stores the transmitted and corresponding original image data. Then, the control unit 1 (controller 1-1) transmits a parameter of the LUT 2-6 (first conversion table data) corresponding to the right-hand drive, to the LUT 2-6 in each display unit 2. The drive circuit 2-3 in each display unit 2, in response to a first drive start instruction from the control unit 1 (controller 1-1), firstly applies a driving voltage based on the right-hand characteristics to display a first image (binary image) on the liquid crystal display panel 2-5. Then, the control unit 1 transmits information on the LUT 2-6 (second conversion table data) corresponding to the left-hand drive, to the LUT 2-6 in each display unit 2. With the updating of table data in the LUT 2-6, the drive circuit 2-3 in each display unit 2, in response to a second drive start instruction from the control unit 1 (controller 1-1), displays a second image based on the left-hand characteristics. At this time, a good black level obtained from the right-hand characteristics is maintained, thereby achieving a high-contrast display.

In this preferred embodiment, since it is necessary to transmit data to a number of display units 2 arranged in a two-dimensional array, common image data is used in the first and second processes (at the right- and left-hand drives) in each display unit 2, and each LUT 2-6 performs each data conversion necessary for the right- and left-hand drives. This considerably increases efficiency in data transmission from the control unit 1 to the display unit 2 as well as simplifies the hardware (H/W) structure.

While the invention has been shown and described in detail, the foregoing description is in all aspects illustrative and not restrictive. It is therefore understood that numerous modifications and variations can be devised without departing from the scope of the invention.

What is claimed is:

1. An image display device comprising:
a liquid crystal display panel using cholesteric liquid crystals; and
a drive system configured to drive said liquid crystal display panel,
said drive system, when an original image to be displayed on said liquid crystal display panel includes halftone components, displaying a first image by a first drive and displaying a second image by a second drive while maintaining a display of said first image on said liquid crystal display panel, thereby to display said original image on said liquid crystal display panel,
said first drive being such that a first drive signal, which is determined by using right-hand characteristics of voltage-reflectance characteristics of said cholesteric liquid crystals based on said original image, is applied to said liquid crystal display panel; and
said second drive being such that, following said first drive, a second drive signal, which is determined by using left-hand characteristics of said voltage-reflectance characteristics based on said original image, is applied to said liquid crystal display panel.

2. The image display device according to claim 1, wherein
said drive system comprises:
a grayscale converter reducing the number of shades of gray of said original image;
a first drive circuit determining, at start timing of said first drive, said first drive signal by use of said right-hand characteristics according to a gray scale of said first image converted by said grayscale converter, and applying said first drive signal to said liquid crystal display panel;
a second drive circuit determining, at start timing of said second drive, said second drive signal by use of said left-hand characteristics according to a gray scale of said original image, and applying said second drive signal to said liquid crystal display panel; and
a controller controlling said start timing of said first drive and said start timing of said second drive.

3. The image display device according to claim 1, wherein
said drive system comprises:
a binary data converter discriminating between a black portion and a portion other than black of original image data representing said original image, and converting said original image into said first image which is a binary image;
a first drive circuit determining, at start timing of said first drive, said first drive signal by use of said right-hand characteristics according to a gray scale of said first image converted by said binary data converter, and applying said first drive signal to said liquid crystal display panel;
a second drive circuit determining, at start timing of said second drive, said second drive signal by use of said left-hand characteristics according to a gray scale of said original image, and applying said second drive signal to said liquid crystal display panel; and
a controller controlling said start timing of said first drive and said start timing of said second drive.

4. The image display device according to claim 1, wherein
said drive system comprises:
an image memory storing original image data representing said original image;
a controller reading and transmitting said original image data from said image memory and controlling start timing of said first drive and start timing of said second drive;
a memory storing said original image data transmitted from said image memory;
a look-up table connected to an output end of said memory and comprising first conversion table data for said first drive and second conversion table data for said second drive; and
a drive circuit applying said first drive signal at said first drive and said second drive signal at said second drive to said liquid crystal display panel,
said first drive signal having being converted using said first conversion table data in said look-up table,
said second drive signal having being converted using said second conversion table data in said look-up table,
said controller setting said first conversion table data at a start of said first drive and said second conversion table data at a start of said second drive, in said look-up table,
said first conversion table data having being produced based on said right-hand characteristics of said voltage-reflectance characteristics and being used for conversion of said original image data into said first drive signal,
said second conversion table data having being produced based on said left-hand characteristics and being used for conversion of said original image data into said second drive signal.

5. The image display device according to claim 3, wherein
said controller sets a variable threshold value in said binary data converter,
said threshold value being used for discrimination between said black portion and said portion other than black of said original image data, and
said binary data converter converts said original image into said binary image using said threshold value as a criterion value.

6. The image display device according to claim 4, wherein
said controller sets table data as said first conversion table data in said look-up table,
said table data being such that, when image data is greater than a variable threshold value used for discrimination between said black portion and said portion other than black of said original image data, said first drive signal is set at a voltage representing a white level determined by said right-hand characteristics, while when said image data is equal to or smaller than said threshold value, said first drive signal is set at a voltage representing a black level determined by said right-hand characteristics.

7. The image display device according to claim 3, wherein
said controller reads optimum attribute information for each said original image to be displayed and sets said attribute information in said binary data converter,
said attribute information having previously being added to each original image data and being used for discrimination between white and black portions, and,
said binary data converter converts said original image into said binary image, using said attribute information as a criterion value.

8. The image display device according to claim 4, wherein
said controller reads optimum attribute information for each said original image to be displayed and sets table data as said first conversion table data in said look-up table,
said attribute information having previously been added to each original image data and being used for discrimination between white and black portions,
said table data being such that, when image data representing said original image to be displayed is greater than said attribute information, said first drive signal is set at a voltage representing a white level determined by said right-hand characteristics, while when said image data is equal to or smaller than said attribute information, said first drive signal is set at a voltage representing a black level determined by said right-hand characteristics.

9. A large image display apparatus comprising:
a control unit; and
a plurality of display units connected to said control unit through a transmission line,
said control unit comprising said image memory and said controller according to claim 4,
said plurality of display units each comprising said memory, said look-up table, said drive circuit, and said liquid crystal display panel using said cholesteric liquid crystals according to claim 4,
said image memory storing original image data that represents said original image to be displayed on each of said plurality of display units;
said controller reading said original image data from said image memory and transmitting said original image data to said memory in each corresponding one of said plurality of display units.
